(19) United States
(12) Patent Application Publication
(10) Pub. No.: US 2016/0183042 A1
(43) Pub. Date: Jun. 23, 2016

(54) LOCATION BLE BEACON

(71) Applicant: Intel Corporation, Santa Clara, CA (US)

(72) Inventors: Raz WEIZMAN, Beer Sheva (IL); Noam S. BROUSARD, Tel Aviv (IL); Idan GUTMAN, Givatayim (IL); Liraz GOLDENTHAL, Ramat-Gan (IL)

(21) Appl. No.: 14/580,689

(22) Filed: Dec. 23, 2014

(51) Int. Cl. H04W 4/02; H04W 4/00

(52) U.S. Cl. CPC H04W 4/02; H04W 4/008

(57) ABSTRACT

Techniques for obtaining device location using a BLE location beacon are provided. Specifically, methods are presented, that when taken alone or together, provide a device or group of devices with an efficient, low power means for obtaining a proximate location using a universally unique identifier.

### TECHNICAL FIELD

Embodiments pertain to wireless networks. Some embodiments relate to wireless networks that operate in accordance with one of the IEEE 802.15 Bluetooth® Specifications. Exemplary embodiments also relate to device location using a Bluetooth® Low Energy (BLE) location beacon.

### BACKGROUND

Consumers are constantly on the go and constantly connected to their wireless electronics. Oftentimes, as consumers are between locations, it is necessary to retrieve location information. Most often, a device Global Positioning System (GPS®) is used to retrieve location information. However, GPS® is largely limited to outdoor use. Therefore, at other instances, the consumer relies upon a cellular or WiFi network connection to obtain this information.

A number of issues arise from this scenario. Some of the issues with GPS are that the process of obtaining location information is very costly/power consuming and computationally intensive. Another issue includes the need for the device to be connected to a network (i.e., WiFi, cellular) to retrieve the information as it relies on Received Signal Strength Indicator (RSSI) triangulation methods and external databases to obtain the location. Still another issue is the frustration introduced to the user as the signal is lost, the power is drained or the device is stalled as the information is retrieved. It is with these and other considerations that the present improvements have been developed.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network environment;

FIG. 2 illustrates an exemplary wireless device;

FIG. 3 illustrates an exemplary communication device;

FIG. 4A illustrates an exemplary BLE packet format;

FIG. 4B illustrates an exemplary format of a Packet Data Unit (PDU);

FIG. 4C illustrates an exemplary format of a Payload with Bluetooth® Low Energy (BLE) location data;

FIG. 5 illustrates an exemplary BLE Advertising (ADV) broadcast with absolute location detection; and

FIG. 6 is a flowchart illustrating detection using Bluetooth® Low Energy (BLE) location beacons.

### DESCRIPTION OF EMBODIMENTS

In the following detailed description, numerous specific details are set forth in order to provide a thorough understanding of the disclosed techniques. However, it will be understood by those skilled in the art that the present embodiments may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like.

Before undertaking the description of embodiments below, it may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, or the like; and the term “controller” means any device, system or part thereof that controls at least one operation, such a device may be implemented in hardware, circuitry, firmware or software, or combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, and/or the Internet, or within a dedicated secured, unsecured, and/or encrypted system and/or within a network operation or management device that is located inside or outside the network. As an example, a wireless device can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof.

Furthermore, it should be appreciated that the various links, including the communications channel(s) connecting the elements can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, this disclosure is intended to include corresponding and complementary receiver-side functionality in both the same transceiver and/or another transceiver(s), and vice versa.

Embodiments may be implemented as part of the Bluetooth® Special Interest Group (SIG), standardized as IEEE 802.15 and Bluetooth Specification Version 4.0 Embodiments may be implemented as part of Wi-Fi Alliance® Technical Committee Hotspot 2.0 Technical Task Group Hotspot 2.0 (Release 2) Technical Specification, Version 2.04, Jan. 2, 2013. Embodiments may be implemented as part of the ISO/IEC 18092/ECMA-340 Near Field Communication Interface and Protocol-1 (NFCCIP-1). Embodiments may be implemented as part of ISO/IEC 21481/ECMA-352 Near Field Communication Interface and Protocol -2 (NFCIP-2). Embodiments may be implemented as part of the ISO/IEC 18004:2006 standards. However, the embodiments are not limited to 802.11 standards, Hotspot 2.0, Bluetooth® standards, and NFC standards. Embodiments can be used in implementation with other wireless communications standards and the like.

Presented herein are embodiments of systems, processes, data structures, user interfaces, etc. The embodiments may relate to a communication device and/or communication system. The communication system can include Bluetooth® Low Energy (BLE), BLE is a wireless Ultra High Frequency (UHF) low energy technology, that entails a Wireless Personal Area Network (WPAN). The communication system can include a Bluetooth® Low Energy (BLE) beacon broadcast. The BLE beacon broadcast can include broadcasting a BLE location beacon to one or more network devices. The overall design and functionality of the system described herein is, as one example, to provide a more efficient means for a device to obtain device location using the BLE location beacon.

Embodiments provide novel networking mechanisms that facilitate a power efficient process for obtaining a device's location. The embodiments generally reduce or remove the need for external means required to obtain a device location by obtaining location information from a BLE location beacon broadcaster. As a result, an omnipresent, faster and less cumbersome means for location identification is achieved while at least reducing device power consumption and providing a user with absolute location information. Other advantages exist as well as will be discussed herein.

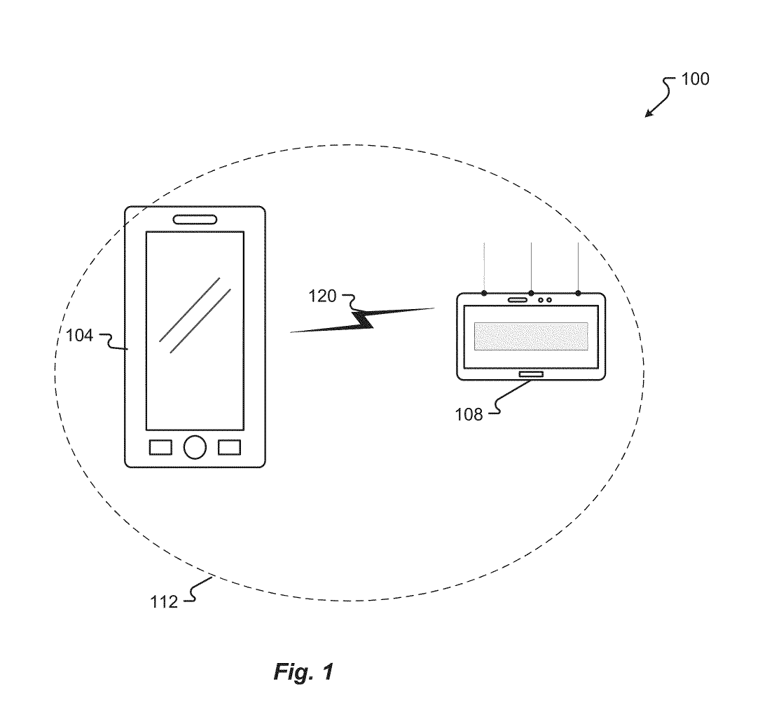

A wireless network environment 100 using Bluetooth® technology is shown in FIG. 1. The wireless network environment 100 can include communication between a wireless device 104 and a communication device 108. The wireless device 104 can be a mobile device, including but not limited to, a mobile phone, a mobile computer, a smart phone, a laptop, a netbook, a personal digital assistant, a tablet, BLE receiver, etc. The communication device 108 can be an access point, a smart phone, a BLE beacon broadcaster, etc. The communication between the wireless device 104 and the communication device 108 can occur using communication channel 120. The communication device 108 can, for example, transmit data, video, audio, beacons, etc., to the wireless device(s) 104 within the proximity or geo-fence 112 of the communication device 108. The communication between devices 104 and 108 can at least include Bluetooth® Low Energy technology and can include connectionless BLE advertising.

An example of a wireless device 104 architecture is shown in FIG. 2. The wireless device 104 may comprise hardware circuitry and/or software that conduct various operations illustrated herein. The wireless device 104 also includes conventional and well known components which have been omitted for clarity. The operations can include, but are not limited, to conducting calls, opening multiple applications, presenting information through audio and/or video means, taking pictures, receiving BLE beacons, etc. The wireless device 104 can be any type of computing system operable to conduct the operations described here. As an example, the wireless device 104 can be a mobile phone which includes and interacts with various modules and components 208-236 as shown in FIG. 2.

The wireless device 104 can have one more antennas 204, for use in wireless communications such as multi-input multi-output (MIMO) communications, Bluetooth®, etc. The antennas 204 can include, but are not limited to directional antennas, omnidirectional antennas, monopoles, patch antennas, loop antennas, microstrip antennas, dipoles, and any other suitable for communication transmission. In an exemplary embodiment, transmission using MIMO may require particular antenna spacing. In another exemplary embodiment, MIMO transmission can enable spatial diversity allowing for different channel characteristics at each of the antennas. In yet another embodiment, MIMO transmission can be used to distribute resources to multiple users.

Antennas 204 generally interact with an Analog Front End (AFE) module 208, which is needed to enable the correct processing of the received modulated signal. The AFE 208 can sit between the antenna and a digital baseband system in order to convert the analog signal into a digital signal for processing.

The wireless device 104 can also include a controller/microprocessor 228 and a memory/storage 224. The wireless device 104 can interact with the memory/storage 224 which may store information and operations necessary for configuring and transmitting or receiving the message frames described herein. The memory/storage 224 may also be used in connection with the execution of application programming or instructions by the controller/microprocessor 228, and for temporary or long term storage of program instructions and/or data. As examples, the memory/storage 224 may comprise a computer-readable device, RAM, ROM, DRAM, SDRAM or other storage devices and media.

The controller/microprocessor 228 may comprise a general purpose programmable processor or controller for executing application programming or instructions related to the wireless device 104. Further, controller/microprocessor 228 can perform operations for configuring and transmitting message frames as described herein. The controller/microprocessor 228 may include multiple processor cores, and/or implement multiple virtual processors. Optionally, the controller/microprocessor 228 may include multiple physical processors. By way of example, the controller/microprocessor 228 may comprise a specially configured Application Specific Integrated Circuit (ASIC) or other integrated circuit, a digital signal processor, a controller, a hardwired electronic or logic circuit, a programmable logic device or gate array, a special purpose computer, or the like.

The wireless device 104 can further include a transmitter 220 and receiver 236 which can transmit and receive signals, respectively, to and from other wireless devices 104 and/or communication devices 108 using one or more antennas 204. Included in the wireless device 104 circuitry is the medium access control or MAC Circuitry 212. MAC circuitry 212 provides the medium for controlling access to the wireless medium. In an exemplary embodiment, the MAC circuitry 212 may be arranged to contend for a wireless medium and configure frames or packets for communicating over the wireless medium. The MAC circuitry 212 can work together or independently of the beacon detection module 216, which can aid in identifying a BLE beacons. The beacon detection module 216 can but is not limited to, detecting BLE location beacons received, processing Universally Unique Identifier (UUIDs) for proximate location determination, filtering/processing other BLE location information for absolute location determination, etc.

The wireless device 104 can also contain a security module 214. This security module 214 can contain information regarding but not limited to, security parameters required to connect the wireless device 104 to communication device 108 or other available networks, and can include security access keys, network keys, etc. In addition, the security module 214 can also perform the processing required to provide both service level security and device level security in a Bluetooth® network such as providing the wireless device with the capability to connect to trusted devices and/or become non-discoverable. Further, the security module 214 can also store and process the Long Term Keys (LTKs) and Short Term Keys (STK) used to encrypt the data transmitted using Bluetooth®.

Another module that the wireless device 104 can include is the network access unit 232. The network access unit 232 can be used for connectivity with the communication device 108. In one exemplary embodiment, the connectivity can include synchronization between devices. In another exemplary embodiment, the network access unit 232 can work as a medium which provides support to the beacon detection module 216 for location detection using a BLE beacon. In yet another embodiment, the network access unit 232 can work in conjunction with at least the MAC circuitry 212. The network access unit 232 can also work and interact with one or more of the modules described herein.

The modules described and others known in the art can be used with the wireless device 104 and can be configured to perform the operations described.

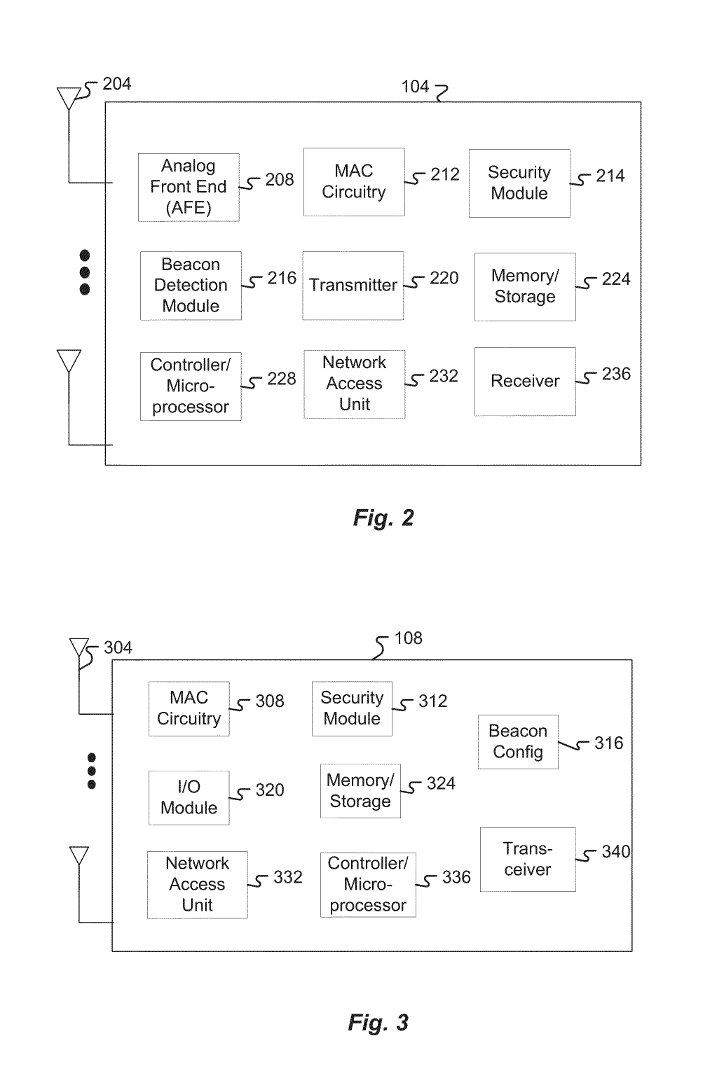

An example of a communication device 108 architecture is shown in FIG. 3. The communication device 108 may comprise hardware and/or software that conduct various operations illustrated herein. The communication device 108 also includes conventional and well known components which have been omitted for clarity. The operations can include, but are not limited, to broadcasting location information, providing a medium for communication between a wireless device 104 and a Bluetooth® network, synchronizing with wireless devices 104, providing hotspot identification, internet connectivity, etc. The communication device 108 can be any type of computing system operable to conduct the operations described here. As an example, the communication device 108 can be a router which includes and interacts with various modules and components 308-340 as shown in FIG. 3.

The communication device 108 can have one more antennas 304, for use in wireless communications such as multi-input single-output (MISO), single-input multi-output (SIMO), MIMO or the like. The antennas 304 can include, but are not limited to directional antennas, omnidirectional antennas, monopoles, patch antennas, loop antennas, microstrip antennas, dipoles, and any other suitable for communication transmission. In an exemplary embodiment, transmission using MIMO may require particular antenna spacing. In another exemplary embodiment, MIMO transmission can enable spatial diversity allowing for different channel characteristics at each of the antennas. In yet another embodiment, MIMO transmission can be used to distribute resources to multiple users.

The communication device 108 can also include most if not all of the same or similar modules as the wireless device 104. For example, for connectivity between devices, the MAC circuitry module 308, network access unit 332 and at least the transceiver 340 are all modules that exist and perform functions such as those described above and in conjunction with FIG. 2. In addition, these modules provide other functions that are known in the art and required for communication with the wireless device 104.

The memory/storage 324 and controller/micro-processor 336 store and process information necessary for at least sensing, scanning, transmitting, receiving, configuring, etc., messages/beacons to be communicated among devices as well as, all other necessary operations as described herein. As examples, the memory/storage 324 may comprise a computer-readable device, RAM, ROM, DRAM, SDRAM or other storage devices and media. The controller/microprocessor 336 may include multiple processor cores, and/or implement multiple virtual processors and may comprise a specially configured Application Specific Integrated Circuit (ASIC) or other integrated circuit, a digital signal processor, a controller, a hardwired electronic or logic circuit, a programmable logic device or gate array, a special purpose computer, or the like.

An input/output (I/O) module 320 can also be part of the communication device 108 architecture. The input/output module 320 and associated ports may be included to support communications over wired or wireless networks or links. For example, I/O module 320 can provide communication with wireless devices 104, servers, communication devices, and/or peripheral devices. Examples of an I/O module 320 include an Ethernet port, a Universal Serial Bus (USB) port, Institute of Electrical and Electronics Engineers (IEEE) port 1394, or other interface.

The beacon configuration module 316 can also be part of the communication device 108, and can but is not limited to, allocating information in a beacon frame for broadcasting to one or more wireless devices 104. Beacon configuration can include allocating information to one or more of the beacon header and payload. Among the information included in a beacon frame is an Advertising Data (AD) length, a CRC (Cyclic Redundancy Check), an AD address, a preamble, and a UUID. The beacon can also provide the wireless device 104 with service specific details and exact beacon location including coordinates and location type of the broadcaster. The beacon configuration module 316 thus, can be used independently, in conjunction with, or in addition to other modules with service discovery information (not shown). In addition, the beacon configuration module 316 can work with other modules such as but not limited to, the network access 332, the controller/microprocessor 336, transceiver 340, and the MAC circuitry 308 to configure and communicate the beacon information to the wireless device 104.

Communication device 108 can also contain a security module 312. The security module 312 will contain information regarding, but not limited to, security parameters required to connect the wireless device 104 to the communication device 108 or other available networks, and can also include WEP or WPA security access keys, network keys, etc.

The modules described and others known in the art can be used with the access point 108 and can be configured to perform the operations described.

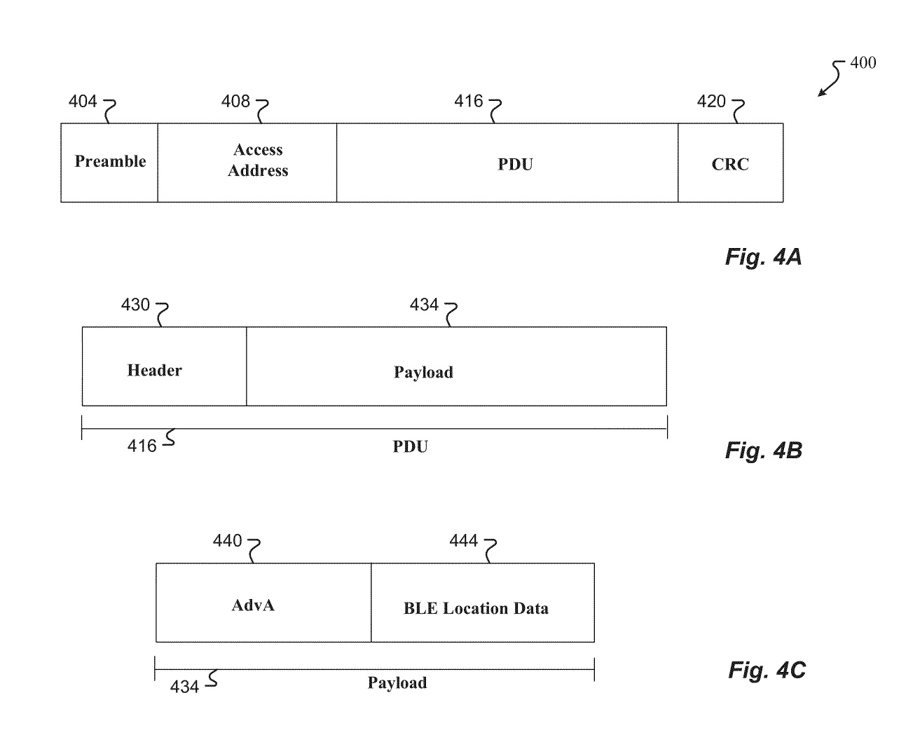

FIG. 4A is an exemplary embodiment for a BLE packet format 400. This BLE packet format 400 contains information that can be used for both advertising channel packets and/or data channel packets. When the BLE packet format 400 is used for advertising channel packets, and it is a connectionless transmission (i.e., only broadcast, no communication), the beacon broadcast is known as BLE ADV broadcast. In general, the BLE packet format 400 includes at least four data fields, the data fields can include a preamble 404, an Access Address 408, a Packet Data Unit (PDU) 416 and a Cyclic Redundancy Check (CRC) 420. The preamble 404 can generally span 8 bits and contains information used for synchronizing, Automatic Gain Control (AGC) training, symbol timing estimation, etc. As an example, 10101010 can be used as the preamble for an advertising channel packet or BLE ADV broadcast. The Access Address 408 can span 8 octets and can vary for each link layer connection when using data channel packets. However, if the Access Address 408 is used for advertising channel packets, then a pre-determined address is used (i.e., Ox8E89BED6). The CRC 420 is an error-detection code that can span 3 octets. The PDU 416 can contain the advertising data and can span between 2 and 39 octets long. As an example, the PDU 416 can contain payload information regarding BLE location as described below and in conjunction with FIGS. 4B and 4C.

FIG. 4B is an exemplary embodiment of PDU 416. The Packet Data Unit 416 in a BLE ADV broadcast contains specific details regarding the advertiser and includes header 430 and a Payload 434 fields. The header 430 can be a 16 bit field that contains information such as, but not limited to the PDU type, RFU, TxAdd, RxAdd, and length. The PDU type is a field defined within the header which contains information regarding the type of PDU used. For example, the PDU type can be ADV_IND, ADV_DIRECT_IND, ADV_SCAN_IND. In another example, the PDU type can be ADV_NONCONN_IND for a non-connectable advertising event (i.e., broadcast of BLE location). The TxAdd and RxAdd fields are fields used as flags to indicate, for example, whether the advertiser's address is public (i.e., TxAdd=0) or random (i.e., TxAdd=1). Alternatively, the TxAdd and RxAdd left undefined can be Reserved For later Use (RFU) or to show that the broadcast is a general public broadcast. The Payload 434 field is a variable field where the data about a host can be included. An exemplary Payload 434 field is depicted in FIG. 4C.

Specifically, FIG. 4C is an exemplary embodiment of a Payload 434 field with Bluetooth® Low Energy location data. In general, the Payload 434 field can span between 6 and 37 octets and contain two (or more) fields. The first field in the Payload 434 field is an Advertiser Address (AdvA) 440 field. The AdvA 440 field contains the actual advertiser's address which was previously flagged in the header 430 of the PDU 416. The second field is the BLE location data 444 field. This field can contain information advertising data from the advertiser's host. In instances where the field information contains BLE location data, the BLE packet format can correspond to a BLE location beacon. As an example, the BLE location data can contain a location Universally Unique Identifier (UUID) that can be used to identify the location of the BLE beacon broadcaster. In general, UUIDs can be independently created and as such a host can decide the best location to place the BLE beacon broadcaster and program the broadcaster with its absolute location. In some embodiments, the wireless device user can enable filters within the wireless device to filter out undesired BLE location beacons based on the BLE Location Data 444 obtained from the Payload 444.

Since the payload 444 field, is a variable length field that can contain varying data, the BLE Location Data 444 field can include, in addition to the location UUID, filters/fields that would provide the wireless device 104 with a more absolute location. The fields can include for example, location type field, a latitude field, a longitude field, floorID field, etc. In general, the fields can include any information usable to assist with location determination.

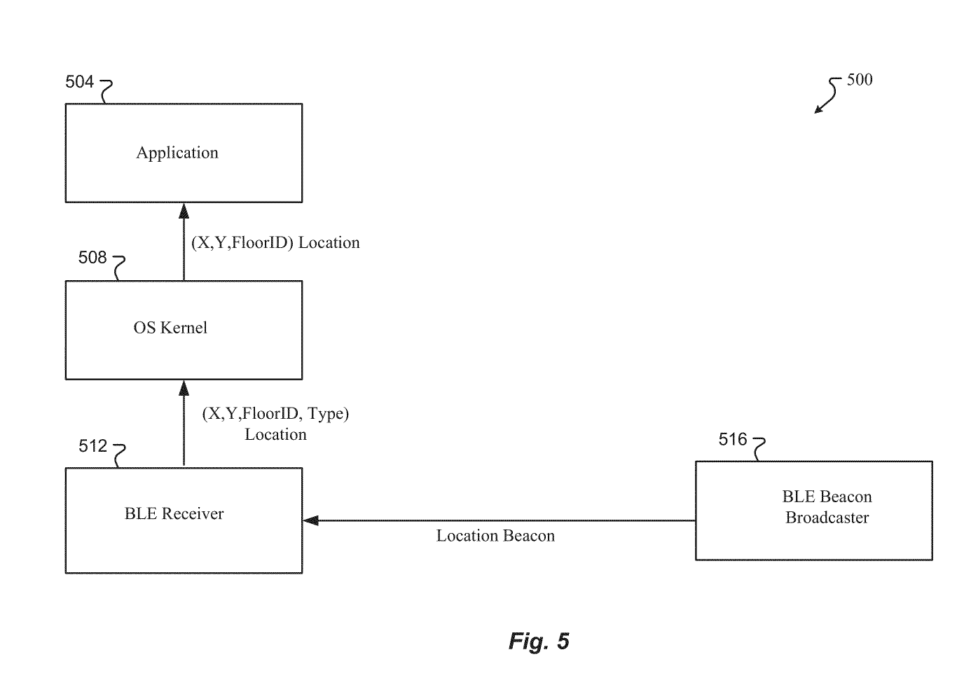

FIG. 5 is an exemplary embodiment of a BLE ADV broadcast with absolute location detection. In some instances, the wireless device user is interested in obtaining a more specific location from a BLE beacon broadcaster. Coordinates and/or entity type can be used to determine the specific/absolute location. FIG. 5 illustrates the process for obtaining such absolute location. The process begins at 516 with BLE beacon broadcaster or communication device 108. The BLE beacon broadcaster or communication device 108 broadcasts a periodic beacon advertising its location using the BLE packet format 400 or BLE location beacon described above and in conjunction with FIGS. 4A-4C. The BLE location beacon will arrive 512 at a BLE receiver or wireless device 104. The BLE receiver or wireless device 104 will receive the beacon, and from the BLE location data determine the BLE beacon broadcaster or communication device location. The information gathered from the BLE location data (i.e., UUID) will identify the advertising element as a location beacon.

To obtain the absolute location, the wireless device can gather the X,Y, FloorID, and Type location information from the BLE location data 444 field. In one example, the X location information can correspond to a 4 byte latitude field and the Y location information can correspond to a 4 byte longitude field. The location can be determined using a coordinate system as detailed in one or more of the following standards: World Geodetic System 1984 (WGS84), European Datum 1950 (ED50), South American Datum (SAD69), Geodetic Reference System 1980 (GRS80), North American Datum 1983 (NAD83), North American Vertical Datum 1988 (NAVD88) and/or European Terrestrial Reference System 1989 (ETRS89), or the like.

In another example, FloorID can correspond to an indoor usage field that can numerically describe the floor the BLE beacon broadcaster is at and Type can correspond to a 1 byte field the BLE broadcast can enable to identify the type of location the beacon is broadcasting from. The Type field can provide the device user to filter location beacon events down to those whose type(s) the user is interested in. The type of locations can include but are not limited to transportation, industry, recreational, tourism, shopping, etc. The Type field can be used as a filter 508 by the OS Kernel such that if the type field received by the wireless device 104 matches the service/application, the mobile device can further process the information received by the application 504 for the exact location obtained by X, Y and FloorID. Alternatively, if the Type is not a match, the location is not of interest to the wireless device or the wireless device is content with a proximate location.

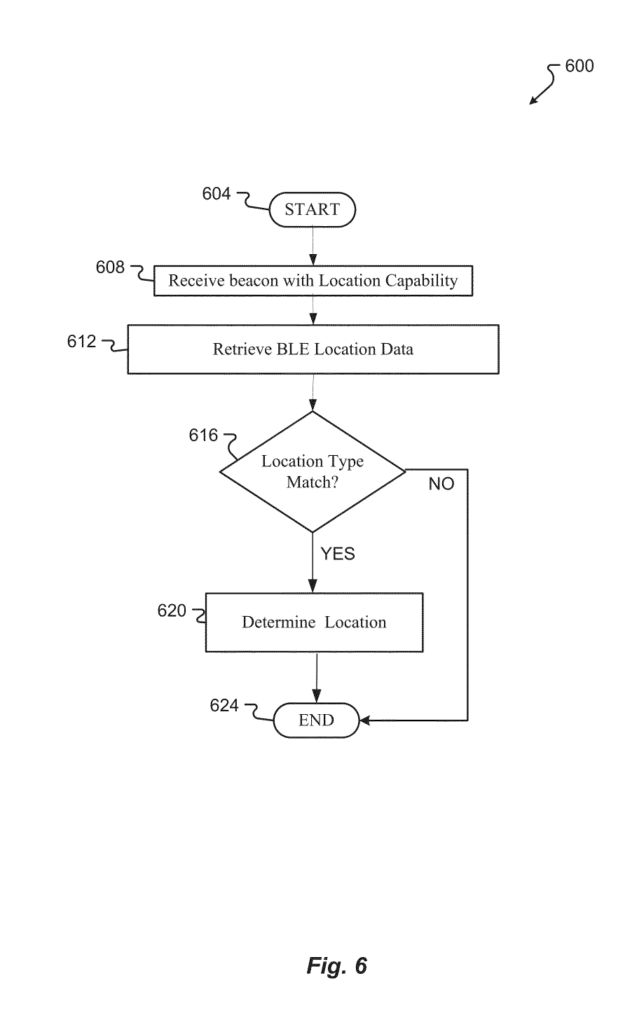

FIG. 6 is a flowchart illustrating an exemplary location detection method using Bluetooth® Low Energy (BLE) location beacons. In particular, the association begins at Step 604 and continues to Step 608. In Step 608 a BLE location beacon is received from a BLE broadcaster at a wireless device that is BLE capable. The BLE beacons are beacons that can be used to broadcast advertisements and services provided by an entity over a BLE ADV broadcast. The BLE location beacon is a BLE ADV beacon with location information. A UUID within the BLE beacon is used to identify the advertising element as a location beacon.

The BLE location data is retrieved from the BLE location beacon in step 612, including the type of location, the location latitude coordinate, the location longitude coordinate, the FloorID, etc. In step 616 location type can be used as a filter. For example, if the device user is only interested in transportation locations, then the filter is set such that only transportation related BLE location beacons are processed and those pertaining to for example, industry, tourism, recreation, etc., are filtered out. Therefore, if the BLE location data matches a location type, the process continues to step 620. Alternatively, if the location type does not match, the process ends at step 624. Further details describing the filters are described in conjunction with FIG. 5. After filter is applied, in step 620 an accurate location is determined using the coordinate and FloorID data received from the BLE location data. The location is determined and the process ends at step 624.

Embodiments are thus directed toward a device for receiving beacon frames, comprising: a memory; a transceiver, the transceiver configured to: receive a plurality of beacon frames with location information from an Ultra High Frequency (UHF) wireless low energy location beacon, wherein the location information is a UHF wireless low energy location data; a processor, the processor configured to: retrieve the UHF wireless low energy location data from the UHF wireless low energy location beacon; process the UHF wireless low energy location data; and obtain a location of the device. Aspects of the above device include wherein the UHF wireless low energy location beacon is a UHF wireless low energy advertising beacon. Aspects of the above device include wherein the UHF wireless low energy location data retrieved includes a location Universally Unique Identifier (UUID). Aspects of the above device include wherein the location UUID wherein the location UUID identifies the UHF wireless low energy location beacon as a location beacon. Aspects of the above device include wherein the UHF wireless low energy location data includes a location type, wherein the location type can be at least one of transportation, shopping, entertainment, or tourism. Aspects of the above device include wherein the UHF wireless low energy location data includes a latitude coordinate, a longitude coordinate, and a floorID. Aspects of the above device include wherein processing the UHF wireless low energy location data further includes determining if UHF wireless low energy location data retrieved matches location filters set by the device, wherein if the location filters do not match the UHF wireless low energy location data retrieved, the UHF wireless low energy location beacon is not used to obtain the location of the device. Aspects of the above device include wherein the location type, the latitude coordinate and the longitude coordinate can provide an absolute location of the device. Aspects of the above device include wherein the device is UHF wireless low energy enabled.

Embodiments include a method for receiving beacon frames, the method comprising: receiving, by a transceiver, a plurality of beacon frames with location information from an Ultra High Frequency (UHF) wireless low energy location beacon, wherein the location information is a UHF wireless low energy location data; retrieving, by a processor, the UHF wireless low energy location data from the UHF wireless low energy location beacon; processing, by the processor, the UHF wireless low energy location data; and obtaining, by the processor, a location of the device. Aspects of the above method include wherein the UHF wireless low energy location beacon is a UHF wireless low energy advertising beacon. Aspects of the above method include wherein the UHF wireless low energy location data retrieved includes a location Universally Unique Identifier (UUID). Aspects of the above method include wherein the location UUID wherein the location UUID identifies the UHF wireless low energy location beacon as a location beacon. Aspects of the above method include wherein the UHF wireless low energy location data includes a location type, wherein the location type can be at least one of transportation, shopping, entertainment, or tourism. Aspects of the above method include wherein the UHF wireless low energy location data includes a latitude coordinate, a longitude coordinate, and a floorID. Aspects of the above method include wherein processing the UHF wireless low energy location data further includes determining if UHF wireless low energy location data retrieved matches location filters set by the device, wherein if the location filters do not match the UHF wireless low energy location data retrieved, the UHF wireless low energy location beacon is not used to obtain the location of the device. Aspects of the above method include wherein the location type, the latitude coordinate and the longitude coordinate can provide an absolute location of the device.

Embodiments include a non-transitory computer readable medium having instructions thereon that when executed by at least one processor of a device perform a method comprising: receiving, by a transceiver, a plurality of beacon frames with location information from an Ultra High Frequency (UHF) wireless low energy location beacon, wherein the location information is a UHF wireless low energy location data; retrieving, by a processor, the UHF wireless low energy location data from the UHF wireless low energy location beacon; processing, by the processor, the UHF wireless low energy location data; and obtaining, by the processor, a location of the device. Aspect of the above media include wherein the UHF wireless low energy location beacon is a UHF wireless low energy advertising beacon. Aspects of the above media include wherein the UHF wireless low energy location data retrieved includes a location Universally Unique Identifier (UUID). Aspects of the above media include wherein the location UUID wherein the location UUID identifies the UHF wireless low energy location beacon as a location beacon. Aspects of the above media include wherein the UHF wireless low energy location data includes a location type, wherein the location type can be at least one of transportation, shopping, entertainment, or tourism. Aspects of the above media include wherein the UHF wireless low energy location data includes a latitude coordinate, a longitude coordinate, and a floorID. Aspects of the above media include wherein processing the UHF wireless low energy location data further includes determining if UHF wireless low energy location data retrieved matches location filters set by the device, wherein if the location filters do not match the UHF wireless low energy location data retrieved, the UHF wireless low energy location beacon is not used to obtain the location of the device. Aspects of the above media include wherein the location type, the latitude coordinate and the longitude coordinate can provide an absolute location of the device.

Embodiments include a system for receiving beacon frames, comprising: means for receiving a plurality of beacon frames with location information from an Ultra High Frequency (UHF) wireless low energy location beacon, wherein the location information is a UHF wireless low energy location data; means for retrieving the UHF wireless low energy location data from the UHF wireless low energy location beacon; means for processing the UHF wireless low energy location data; and means for obtaining a location of the device. Aspects of the above system include wherein the UHF wireless low energy location beacon is a UHF wireless low energy advertising beacon. Aspects of the above system include wherein the UHF wireless low energy location data retrieved includes a location Universally Unique Identifier (UUID). Aspects of the above system include wherein the location UUID wherein the location UUID identifies the UHF wireless low energy location beacon as a location beacon. Aspects of the above system include wherein the UHF wireless low energy location data includes a location type, wherein the location type can be at least one of transportation, shopping, entertainment, or tourism. Aspects of the above system include wherein the UHF wireless low energy location data includes a latitude coordinate, a longitude coordinate, and a floorID. Aspects of the above system include wherein processing the UHF wireless low energy location data further includes determining if UHF wireless low energy location data retrieved matches location filters set by the device, wherein if the location filters do not match the UHF wireless low energy location data retrieved, the UHF wireless low energy location beacon is not used to obtain the location of the device. Aspects of the above system include wherein the location type, the latitude coordinate and the longitude coordinate can provide an absolute location of the device.

Embodiments include a communication device for transmitting beacon frames, comprising: a memory; a transceiver, the transceiver configured to: transmit a plurality of beacon frames with location information, wherein the location information is a UHF wireless low energy location data, and wherein the UHF wireless low energy location data includes at least one of a location Universally Unique Identifier (UUID), a latitude coordinate, a location type, and a floorID.

The exemplary embodiments are described in relation to location detection using Bluetooth® Low Energy. However, it should be appreciated, that in general, the systems and methods herein will work equally well for any type of communication system in any environment utilizing any one or more protocols including wired communications, wireless communications, powerline communications, coaxial cable communications, fiber optic communications and the like.

The exemplary systems and methods are described in relation to Bluetooth® enabled transceivers and associated communication hardware, software and communication channels. However, to avoid unnecessarily obscuring the present disclosure, the following description omits well-known structures and devices that may be shown in block diagram form or otherwise summarized.

For purposes of explanation, numerous details are set forth in order to provide a thorough understanding of the present embodiments. It should be appreciated however, that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an 802.11 transceiver, or the like. Examples of wireless protocols that can be used with this technology include 802.11a, 802.11b, 802.11g, 802.11n, 802.11ac, 802.11ad, 802.11af, 802.11ah, 802.11ai, 802.11aj, 802.11aq, 802.11ax, 802.11u, WiFi, LTE, LTE Unlicensed, 4G, Bluetooth®, WirelessHD, WiGig, 3GPP, Wireless LAN, WiMAX.

The term transceiver as used herein can refer to any device that comprises hardware, software, firmware, or combination thereof and is capable of performing any of the methods described herein.

Additionally, the systems, methods and protocols can be implemented on one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can be used to implement the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22 nm Ivy Bridge, the AMDC®, FX™ family of processors, AMD®, FX-4300, FX-6300, and FX-8350 32 nm Vishera, AMDC®, Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium, executed on programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has been provided systems and methods for BLE beacon location. While the embodiments have been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this disclosure.

1. A device operating in a near-field communication environment or an IEEE 802.15 environment, comprising:
a memory;
a transceiver, the transceiver configured to:
receive a plurality of beacon frames with location information from an Ultra High Frequency (UHF) wireless low energy location beacon operating in accordance with one of the environment, wherein: the plurality of beacon frames include advertising channel packets and an advertiser address, and the location information is a UHF wireless low energy location data;
a processor, the processor configured to:
retrieve the UHF wireless low energy location data from the UHF wireless low energy location beacon;
process the UHF wireless low energy location data; and
obtain a location of the device.

2. The device of claim 1, wherein the UHF wireless low energy location beacon is a UHF wireless low energy advertising beacon.

3. The device of claim 1, wherein the UHF wireless low energy location data retrieved includes a location Universally Unique Identifier (UUID).

4. The device of claim 3, wherein the location UUID identifies the UHF wireless low energy location beacon as a location beacon.

5. The device of claim 1, wherein the UHF wireless low energy location data includes a location type, wherein the location type can be at least one of transportation, shopping, entertainment, or tourism.

6. The device claim 5, wherein the UHF wireless low energy location data includes a latitude coordinate, a longitude coordinate, and a floorID.

7. The device of claim 6, wherein processing the UHF wireless low energy location data further includes determining if UHF wireless low energy location data retrieved matches location filters set by the device, wherein if the location filters do not match the UHF wireless low energy location data retrieved, the UHF wireless low energy location beacon is not used to obtain the location of the device.

8. The device of claim 7, wherein the location type, latitude coordinate and longitude coordinate can provide an absolute location of the device.

9. The device of claim 1, wherein the device is UHF wireless low energy enabled.

10. A method comprising:
receiving, by a transceiver, a plurality of beacon frames with location information from an Ultra High Frequency (UHF) wireless low energy location beacon operating in a near-field communication environment or an IEEE 802.15 environment, wherein: the plurality of beacon frames include advertising channel packets and an advertiser address, and the location information is a UHF wireless low energy location data;
retrieving, by a processor, the UHF wireless low energy location data from the UHF wireless low energy location beacon;
processing, by the processor, the UHF wireless low energy location data; and
obtaining, by the processor, a location of the device.

11. The method of claim 10, wherein the UHF wireless low energy location beacon is a UHF wireless low energy advertising beacon.

12. The method of claim 10, wherein the UHF wireless low energy location data retrieved includes a location Universally Unique Identifier (UUID).

13. The method of claim 12, wherein the location UUID wherein the location UUID identifies the UHF wireless low energy location beacon as a location beacon.

14. The method of claim 10, wherein the UHF wireless low energy location data includes a location type, a latitude coordinate, a longitude coordinate, and a floorID, and wherein the location type, the latitude coordinate and the longitude coordinate can provide an absolute location of the device.

15. The method of claim 10, wherein processing the UHF wireless low energy location data further includes determining if UHF wireless low energy location data retrieved matches location filters set by the device, wherein if the location filters do not match the UHF wireless low energy location data retrieved, the UHF wireless low energy location beacon is not used to obtain the location of the device.

16. A non-transitory computer readable medium having instructions thereon that when executed by at least one processor of a device perform a method comprising:
receiving, by a transceiver, a plurality of beacon frames with location information from an Ultra High Frequency (UHF) wireless low energy location beacon operating in a near-field communication environment or an IEEE 802.15 environment, wherein: the plurality of beacon frames includes advertising channel packets and an advertiser address, and the location information is a UHF wireless low energy location data;
retrieving, by a processor, the UHF wireless low energy location data from the UHF wireless low energy location beacon;
processing, by the processor, the UHF wireless low energy location data; and
obtaining, by the processor, a location of the device.

17. The non-transitory medium of claim 16, wherein the UHF wireless low energy location data retrieved includes a location Universally Unique Identifier (UUID), and wherein the location UUID wherein the location UUID identifies the UHF wireless low energy location beacon as a location beacon.

18. The non-transitory medium of claim 16, wherein the UHF wireless low energy location data includes a location type, a latitude coordinate, a longitude coordinate, and a floorID, and wherein the location type, the latitude coordinate, and the longitude coordinate can provide an absolute location of the device.

19. The non-transitory medium of claim 16, wherein processing the UHF wireless low energy location data further includes determining if UHF wireless low energy location data retrieved matches location filters set by the device, wherein if the location filters do not match the UHF wireless low energy location data retrieved, the UHF wireless low energy location beacon is not used to obtain the location of the device.

20. A communication device operating in a near-field communication environment or an IEEE 802.15 environment for transmitting beacon frames, comprising:
a memory;
a transceiver operating in accordance with one of the environments, the transceiver configured to:
transmit a plurality of beacon frames with location information, wherein: the plurality of beacon frames include advertising channel packets and an advertiser address, and the location information is a UHF wireless low energy location data, and wherein the UHF wireless low energy location data includes at least one of a location Universally Unique Identifier (UUID), a latitude coordinate, a location type, and a floorID.
